(19) United States
(12) Patent Application Publication
(10) Pub. No.: US 2025/0132078 A1
(43) Pub. Date: Apr. 24, 2025

(54) SUPERCONDUCTING COIL DEVICE COMPRISING REMOVABLE WINDING FRAME AND MANUFACTURING METHOD THEREOF

(71) Applicant: KOREA BASIC SCIENCE INSTITUTE, Daejeon (KR)

(72) Inventors: Seunghyun SONG, Daejeon (KR); Yeon Suk CHOI, Daejeon (KR); Yojong CHOI, Daejeon (KR)

(21) Appl. No.: 18/900,577

(22) Filed: Sep. 27, 2024

(30) Foreign Application Priority Data
Oct. 23, 2023 (KR) 10-2023-0142490

(51) Int. Cl. H01F 6/06

(52) U.S. Cl. CPC H01F 6/06

(57) ABSTRACT

A superconducting coil device including a removable winding frame includes an upper flange, a lower flange provided at a position apart from the upper flange, a plurality of connecting rods for connecting the upper flange to the lower flange, an upper fixing plate detachably connected to a top surface of the upper flange, a lower fixing plate detachably connected to a bottom surface of the lower flange, and a winding frame detachably connected between the upper fixing plate and the lower fixing plate, provided to support a wound coil, and detachable from the coil, the upper flange, and the lower flange while the coil is wound.

### CROSS-REFERENCE TO RELATED APPLICATIONS

This application claims the benefit under 35 USC § 119(a) of Korean Patent Application No. 10-2023-0142490, filed on Oct. 23, 2023, in the Korean Intellectual Property Office, the entire disclosure of which is incorporated herein by reference for all purposes.

### BACKGROUND

### 1. Field

The following description relates to a superconducting device including a removable winding frame and a manufacturing method thereof.

### 2. Description of Related Art

A superconducting coil device may include a superconducting coil provided by winding a superconducting wire on a winding frame. The wire may refer to a unit body that forms the coil. When manufacturing a superconducting coil device, the use of the winding frame without removing the winding frame after the coil is manufactured may result in an unnecessary use of refrigerants. In a refrigerant-immersed superconducting coil device, the cooling efficiency may decrease since a contact area between a refrigerant and a superconducting coil is restricted. Due to the winding frame not being removed after a coil device is manufactured, the utilization of an inner space of the coil may decrease and the volume and uniformity of a central magnetic field coil and the wire consumption may decrease.

When the winding frame is positioned between the wire of the superconducting coil and a refrigerant for cooling, the cooling efficiency may be impeded by the winding frame when cooling the coil. In a process of generating a magnetic field using the superconducting coil, in the case of initial cooling using a refrigerant (e.g., a cryogenic fluid), the winding frame may need to be cooled together, and thus, when the winding frame is present, the cooling time may increase and the use of refrigerant may increase. If the winding frame is positioned inside the superconducting coil, a test space for measuring a physical property using a magnetic field may be reduced, and thereby, the space utilization may decrease. To manufacture a superconducting coil device, there is a demand for techniques for efficiently using a refrigerant, decreasing the wire consumption, and increasing the cooling efficiency of the coil, the space utilization of an inner bore, the size of a central magnetic field, the volume and uniformity of the coil.

The above description has been possessed or acquired by the inventor(s) in the course of conceiving the present disclosure and is not necessarily an art publicly known before the present application is filed.

### SUMMARY

A goal according to an embodiment is providing a superconducting device including a removable winding frame and a manufacturing method thereof.

According to an embodiment, a superconducting coil device including a removable winding frame includes an upper flange, a lower flange provided at a position apart from the upper flange, a plurality of connecting rods for connecting the upper flange to the lower flange, an upper fixing plate detachably connected to a top surface of the upper flange, a lower fixing plate detachably connected to a bottom surface of the lower flange, and a winding frame detachably connected between the upper fixing plate and the lower fixing plate, provided to support a wound coil, and detachable from the coil, the upper flange, and the lower flange while the coil is wound.

In an embodiment, the winding frame includes a plurality of frame bodies detachable from the upper flange and the lower flange and detachable from each other.

In an embodiment, the plurality of frame bodies is apart from each other while being fixed to the upper flange and the lower flange.

In an embodiment, two adjacent frame bodies of the plurality of frame bodies are in line contact with each other while being fixed to the upper flange and the lower flange.

In an embodiment, some of the plurality of frame bodies include different materials.

In an embodiment, each of the upper flange and the upper fixing plate includes a hole to pass a wire that forms a coil.

In an embodiment, upper flange includes an upper flange body including a plate shape, and an upper flange hole formed through the upper flange body and provided to pass the wire therethrough.

In an embodiment, the upper flange includes an upper flange groove recessed in a bottom surface of the upper flange body that faces the lower flange and formed around the upper flange hole.

In an embodiment, the upper fixing plate includes an upper fixing plate body including a plate shape and disposed in the flange body, and an upper fixing plate hole formed through the upper fixing plate body and overlapping the upper flange hole.

In an embodiment, a size of the upper fixing plate hole is greater than a size of the upper flange hole.

In an embodiment, the upper fixing plate further includes an upper fixing plate guide provided at an edge portion of the upper fixing plate hole and including a curved surface.

In an embodiment, an upper end of the winding frame is inserted into the upper flange and a lower end of the winding frame is inserted into the lower flange.

In an embodiment, a top surface of the winding frame is in surface contact with the upper fixing plate and a bottom surface of the winding frame is in surface contact with the lower fixing plate.

According to an embodiment, a method of manufacturing a superconducting coil device includes engaging a winding frame with an upper flange and a lower flange, installing a plurality of connecting rods between the upper flange and the lower flange, installing an upper fixing plate on an upper side of the upper flange, installing a lower fixing plate on a lower side of the lower flange, forming a coil by passing a wire through the upper fixing plate and the upper flange and winding the coil on the winding frame, separating the upper fixing plate from the upper flange, separating the lower fixing plate from the lower flange, and separating the winding frame from the upper flange and the lower flange.

A superconducting coil device according to an embodiment may efficiently use a refrigerant when cooling and may increase the cooling efficiency of a coil by providing a removable winding frame. Specifically, since the winding frame is removed, the refrigerant may directly contact the coil, and thereby, the coil may be effectively cooled. Since the winding frame is removable, the use of refrigerant required for cooling the device may decrease. By removing a frame in an inner bore, the cooling efficiency of a coil may be improved by increasing a contact area between a refrigerant and the superconducting coil.

A superconducting coil device according to an embodiment may secure a sufficient space inside a coil, in other words, a space of an inner bore since a winding frame is removable. A specimen for measuring various physical properties may be sufficiently inserted into the space in the inner bore. A solenoid-type superconducting coil may have the greatest magnetic field strength in the inner bore, and typically, a device, such as MRI, NMR, and PPMS, may dispose their subject, probe, and shim coil in the inner bore. Accordingly, it is important to secure the inner bore space as wide as possible. A coil device may improve the utilization of an inner bore space, the size of a central magnetic field, wire consumption, and volume and uniformity of the coil compared to a conventional method by removing a winding frame after winding.

A superconducting coil device according to an embodiment may increase the size of a central magnetic field, may form a coil with a sufficiently strong magnetic field while reducing the wire consumption, and may improve the volume and uniformity of the coil.

A superconducting coil device according to an embodiment may reduce the use of a refrigerant for initial cooling by removing a winding frame after manufacturing a superconducting coil.

A superconducting coil device according to an embodiment may have a structure that segments a body into several pieces in a lateral direction and reduces mechanical resistance by securing an empty space between adjacent body components, and thereby, a winding frame may be easily removed.

Other features and aspects will be apparent from the following detailed description, the drawings, and the claims.

### BRIEF DESCRIPTION OF THE DRAWINGS

FIG. 1 is a perspective view of a superconducting coil device with a removable winding frame according to an embodiment.

FIG. 2 is a perspective view of a superconducting coil device with a removable winding frame according to an embodiment.

FIG. 3 is a perspective view of an upper fixing plate according to an embodiment.

FIG. 4 is a perspective view of an upper flange according to an embodiment.

FIG. 5 is a perspective view of an upper flange according to an embodiment.

FIG. 6 is a schematic cross-sectional view of a superconducting coil device with a removable winding frame according to an embodiment.

FIG. 7 is a schematic cross-sectional view of a state in which a winding frame is removed from a superconducting coil device according to an embodiment.

FIG. 8A is a schematic view of a superconducting coil device from which a winding frame is not removable.

FIG. 8B is a schematic view of a superconducting coil device from which a winding frame is removed according to an embodiment.

FIG. 9A is a schematic view of a superconducting coil device from which a winding frame is not removable.

FIG. 9B is a schematic view of a superconducting coil device from which a winding frame is removed according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

Hereinafter, embodiments will be described in detail with reference to the accompanying drawings. The following description describes one of several aspects of the embodiments, and the following description forms part of the detailed description of the embodiments. In the description of an embodiment, any detailed description of a well-known function or configuration is not included to clearly convey the gist of the present disclosure.

However, various alterations and modifications may be made to the embodiments. Thus, the embodiments are not meant to be limited by the descriptions of the present disclosure. The embodiments should be understood to include all changes, equivalents, and replacements within the idea and the technical scope of the disclosure.

In addition, the terms or words used to describe the present disclosure and claims should not be construed in a conventional or dictionary meaning, and based on a principle that the inventor may properly define the concept of terms in order to best describe their invention, the terms or words should be construed as having meanings and concepts consistent with the technical idea of the disclosure according to an embodiment.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms defined in dictionaries generally used should be construed as having meanings matching contextual meanings in the related art and are not to be construed as having an ideal or excessively formal meaning unless otherwise defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the embodiments described above and an element having a common function. Unless otherwise mentioned, the description on one embodiment may be applicable to other embodiments and thus, duplicated descriptions will be omitted for conciseness.

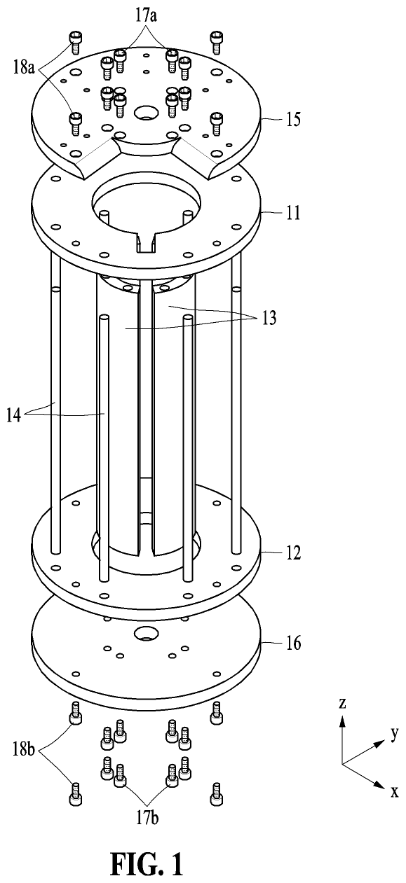

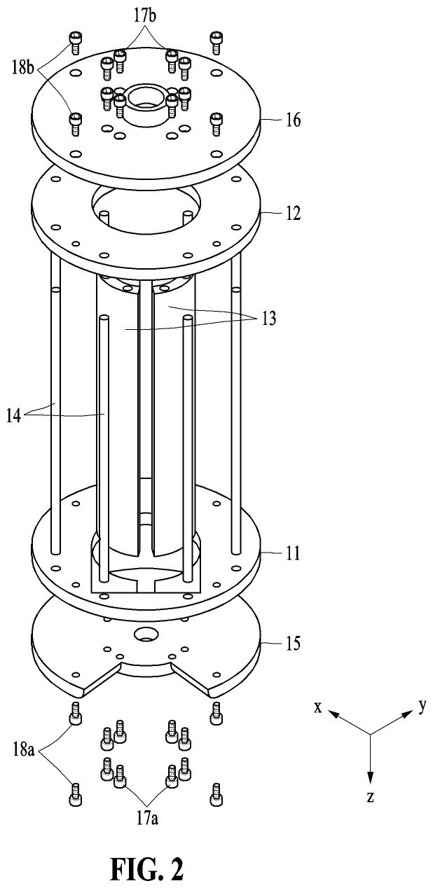

FIG. 1 is a perspective view of a superconducting coil device with a removable winding frame according to an embodiment. FIG. 2 is a perspective view of a superconducting coil device with a removable winding frame according to an embodiment.

Referring to FIGS. 1 and 2, a superconducting coil device with a removable winding frame (hereinafter, referred to as a “coil device”) according to an embodiment may support a coil (not shown). The coil may be a bundle of wound coils. The wire may enter the coil device and may be wound on the winding frame. The coil device may include a removable winding frame. In this case, the term removable may refer to detachable. The coil device may remove the winding frame when the coil is completely wound. When the winding frame is removed, the coil wound on the winding frame may remain, and the winding frame may be separated. The coil device may include an upper flange 11, a lower flange 12, a winding frame 13, a plurality of connecting rods 14, an upper fixing plate 15, a lower fixing plate 16, a first upper fixing member 17a, a second upper fixing member 18a, a first lower fixing member 17b, and a second lower fixing member 18b.

The upper flange 11 may cover an upper side of a coil (not shown). The upper flange 11 may prevent the coil from being separated upward. The upper flange 11 may provide a space in which a wire enters from the outside. The upper flange 11 may have a plate shape.

The lower flange 12 may support a lower side of the coil (not shown). The lower flange 12 may be provided at a position apart from the upper flange 11 in the z direction. The lower flange 12 may be provided in parallel with the upper flange 11. The height of the coil may be less or equal to a gap between the upper flange 11 and the lower flange 12. The lower flange 12 may have a plate shape.

The winding frame 13 may support the coil. The wire may be wound on an outer surface of the winding frame 13. The winding frame 13 may be provided inside the coil. The winding frame 13 may be detachable from the upper flange 11 and the lower flange 12. An upper end of the winding frame 13 may be inserted into the upper flange 11. The upper flange 11 may enclose the winding frame 13. A lower end of the winding frame 13 may be inserted into the lower flange 12. The lower flange 12 may enclose the winding frame 13. The winding frame 13 may include a plurality of frame bodies. The plurality of frame bodies may be detachable from each other. Each of the plurality of frame bodies may be inserted into the upper flange 11 and the lower flange 12. Although the drawing illustrates that the number of the plurality of frame bodies 13 is four, but the number is not limited thereto. For example, the number of the plurality of frame bodies 13 may be two, three, or six.

Among the plurality of frame bodies 13, two adjacent frame bodies may be at least partially separated from each other. According to the structure described above, the plurality of frame bodies 13 may be easily separated from each other without great resistance. Each of the plurality of frame bodies 13 may be detachably connected to the upper flange 11 and the lower flange 12. For example, two adjacent frame bodies may be in line contact with each other. For example, outer edges of two adjacent frame bodies may be maintained in contact with each other.

At least a portion of the plurality of frame bodies 13 may include different materials. According to the structure described above, two adjacent frame bodies that are in contact with each other but include different materials may be easily separated.

The plurality of connecting rods 14 may connect the upper flange 11 to the lower flange 12. Although the drawing illustrates that the number of the plurality of connecting rods 14 is eight, but the number is not limited thereto. For example, an upper end of the plurality of connecting rods 14 may be connected to the upper flange 11, and a lower end thereof may be connected to the lower flange 12. For example, the plurality of connecting rods 14 may be inserted into the upper flange 11 and the lower flange 12.

The upper fixing plate 15 may be disposed on the upper flange 11. The upper fixing plate 15 may be disposed on the upper side of the upper flange 11. In the present disclosure, the upper side may refer to the +z direction. The upper fixing plate 15 may be fixed to the upper flange 11 and the winding frame 13. For example, the first upper fixing member 17a may fix the upper fixing plate 15 and the winding frame 13. For example, the first upper fixing member 17a may pass the upper fixing plate 15 and may be fixed to the winding frame 13. The second upper fixing member 18a may fix the upper fixing plate 15 and the upper flange 11. For example, the second upper fixing member 18a may pass the upper fixing plate 15 and may be fixed to the upper flange 11. For example, when the first upper fixing member 17a is released, a fixing state of upper fixing plate 15 and the winding frame 13 may be released. When the second upper fixing member 18a is released, a fixing state of the upper fixing plate 15 and the upper flange 11 may be released. When the first upper fixing member 17a and the second upper fixing member 18a are released, the upper fixing plate 15 may be separated from the upper flange 11, and the winding frame 13 may be separated.

The lower fixing plate 16 may be disposed on the lower flange 12. The lower fixing plate 16 may be disposed on a lower side of the lower flange 12. In the present disclosure, the lower side may refer to the −z direction. The lower fixing plate 16 may be fixed to the lower flange 12 and the winding frame 13. For example, the first lower fixing member 17b may fix the lower fixing plate 16 and the winding frame 13. For example, the first lower fixing member 17b may pass the lower fixing plate 16 and may be fixed to the winding frame 13. The second lower fixing member 18b may fix the lower fixing plate 16 and the lower flange 12. For example, the second lower fixing member 18b may pass the lower fixing plate 16 and may be fixed to the lower flange 12. For example, when the first lower fixing member 17b is released, a fixing state of the lower fixing plate 16 and the winding frame 13 may be released. When the second lower fixing member 18b is released, a fixing state of the lower fixing plate 16 and the lower flange 12 may be released. When the first lower fixing member 17b and the second lower fixing member 18b are released, the lower fixing plate 16 may be separated from the lower flange 12, and the winding frame 13 may be separated.

A method of manufacturing a superconducting coil device may include an operation of engaging the winding frame 13 with the upper flange 11 and the lower flange 12, an operation of installing the plurality of connecting rods 14 between the upper flange 11 and the lower flange 12, an operation of installing the upper fixing plate 15 on the upper side of the upper flange 11, an operation of installing the lower fixing plate 16 on the lower side of the lower flange 12, an operation of forming the coil by passing the wire through the upper fixing plate 15 and the upper flange 11 and winding the wire on the winding frame 13, an operation of separating the upper fixing plate 15 from the upper flange 11, an operation of separating the lower fixing plate 16 from the lower flange 12, and an operation of separating the winding frame 13 from the upper flange 11 and the lower flange 12.

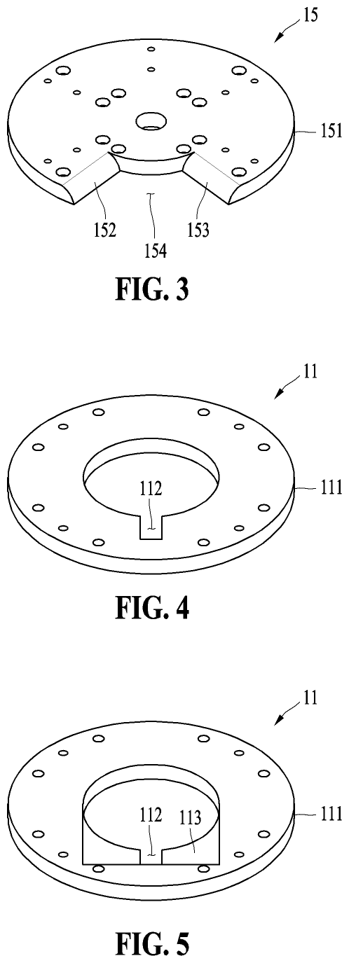

FIG. 3 is a perspective view of an upper fixing plate according to an embodiment. FIG. 4 is a perspective view of an upper flange according to an embodiment. FIG. 5 is a perspective view of an upper flange according to an embodiment.

Referring to FIGS. 3 to 5, the upper fixing plate 15 may include an upper fixing plate body 151, an upper fixing plate hole 154, and upper fixing plate guides 152 and 153.

The upper fixing plate body 151 may have a plate shape.

The upper fixing plate hole 154 may be formed through the upper fixing plate body 151. The upper fixing plate hole 154 may overlap an upper flange hole 112. The size of the upper fixing plate hole 154 may be greater than the size of the upper flange hole 112.

The upper fixing plate guides 152 and 153 may be provided at an edge portion of the upper fixing plate hole 154 and may have a curved surface. The upper fixing plate guides 152 and 153 may include a first guide 152 provided at one edge of the upper fixing plate hole 154 and a second guide 153 provided at the other edge of the upper fixing plate hole 154. The upper fixing plate guide 152 and 153 may reduce or prevent an event of the wire (not shown) being excessively bent.

The upper flange 11 may include an upper flange body 111, the upper flange hole 112, and an upper flange groove 113. The upper flange 11 may be provided between the upper fixing plate 15 and the lower flange 12 (referring to FIG. 1).

The upper flange body 111 may have a plate shape. The upper flange body 111 may be positioned lower than the upper fixing plate body 151.

The upper flange hole 112 may be formed through the upper flange body 111 to pass the wire therethrough. The upper flange hole 112 may be positioned below the upper fixing plate hole 154.

The upper flange groove 113 may be recessed in a surface of the upper flange bottom surface 111 that faces the lower flange 12 (referring to FIG. 1) and may be formed around the upper flange hole 112. The upper flange groove 113 may reduce or prevent an event of the wire (not shown) being excessively bent.

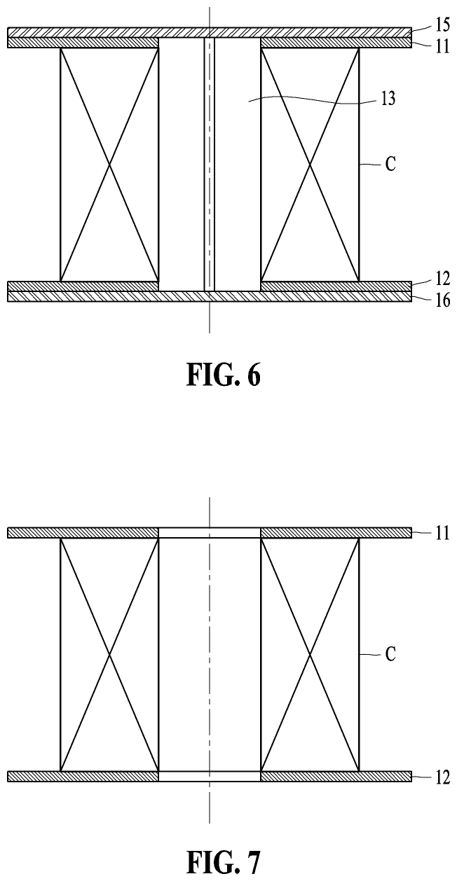

FIG. 6 is a schematic cross-sectional view of a superconducting coil device with a removable winding frame according to an embodiment. FIG. 7 is a schematic cross-sectional view of a state in which a winding frame is removed from a superconducting coil device according to an embodiment.

Referring to FIGS. 6 and 7, a wire may be wound while the upper flange 11, the lower flange 12, the winding frame 13, the upper fixing plate 15, and the lower fixing plate 16 are fastened. When the wire is wound, a coil C may be formed. While the coil is formed, the winding frame 13, the upper fixing plate 15, and the lower fixing plate 16 may be separated from the upper flange 11 and the lower flange 12.

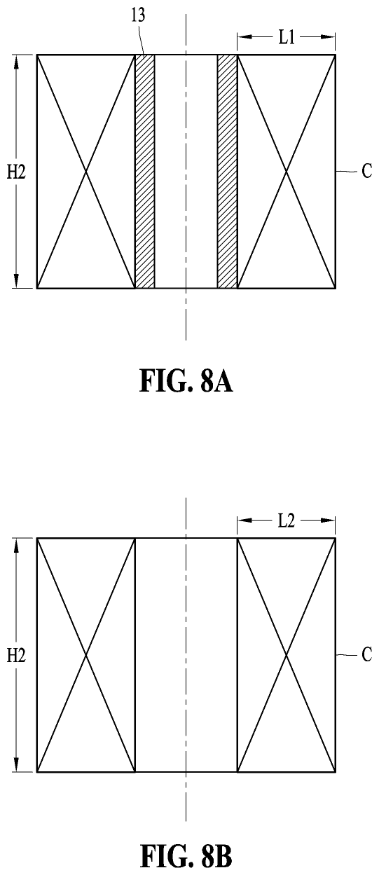

FIG. 8A is a schematic view of a superconducting coil device from which a winding frame is not removable. FIG. 8B is a schematic view of a superconducting coil device from which a winding frame is removed according to an embodiment.

Referring to FIGS. 8A and 8B, when comparing cases where the winding frame 13 exists and where the winding frame is removed whereas widths L1 and L2 and a height H2 of the coil C are the same, there may be a difference in a space into which a specimen is inserted. For example, when the winding frame is removed, a relatively wide specimen space may be secured. When the amount of wire consumption is the same, a space into which a specimen is inserted may be sufficiently secured by removing the winding frame.

By removing the winding frame, the technical effects of reducing a cooling element and refrigerant consumption may be achieved. By removing the winding frame, the cooling efficiency may increase by reducing a heat transmission path and the temperature rise in the coil due to internal magnet heat may be reduced.

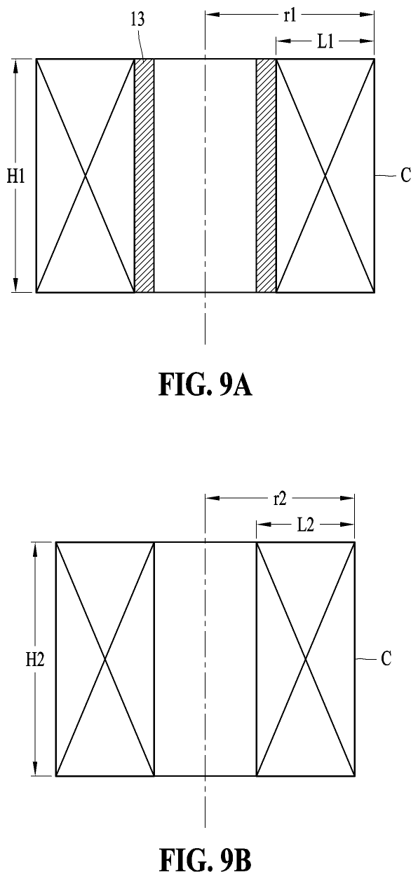

FIG. 9A is a schematic view of a superconducting coil device from which a winding frame is not removable. FIG. 9B is a schematic view of a superconducting coil device from which a winding frame is removed according to an embodiment.

Referring to FIGS. 9A and 9B, when comparing cases where the winding frame 13 exists and where the winding frame is removed whereas heights H1 and H2 are the same, there may be a difference in overall diameters r1 and r2 and the widths L1 and L2 of the coil C. For example, when the winding frame is removed, the width L2 of the coil C may be relatively greater than the width L1. When a specimen space and a central magnetic field are the same and the winding frame is removed, more superconducting wires may be wound as much as the thickness, and thus, the wire consumption and the coil volume may be reduced according to the Biot-Savart law.

By removing the winding frame, the technical effects of reducing a cooling element and refrigerant consumption may be achieved. By removing the winding frame, the cooling efficiency may increase by reducing a heat transmission path and the temperature rise in the coil due to internal magnet heat may be reduced.

Furthermore, although not shown in the drawings, when the coil consumption is the same and the winding frame is removed, the height of the coil may increase, and in this case, since a spatial magnetic field is distributed longer in an axial direction, the uniformity may be improved in a coil DSV.

Embodiments have been described above with reference to specific matters such as specific components and limited embodiments and with reference to drawings, but these are provided to facilitate overall understanding. Also, the present disclosure is not limited to the above-described embodiments, and various modifications and variations are possible from these descriptions by those skilled in the art to which the present disclosure pertains. Accordingly, the scope of the present disclosure is defined not by the detailed description, but by the claims and their equivalents, and all variations within the scope of the claims and their equivalents are to be construed as being included in the disclosure.

What is claimed is:

1. A superconducting coil device comprising a removable winding frame, the superconducting coil device comprising:
an upper flange;
a lower flange provided at a position apart from the upper flange;
a plurality of connecting rods for connecting the upper flange to the lower flange;
an upper fixing plate detachably connected to a top surface of the upper flange;
a lower fixing plate detachably connected to a bottom surface of the lower flange; and
a winding frame detachably connected between the upper fixing plate and the lower fixing plate, provided to support a wound coil, and detachable from the coil, the upper flange, and the lower flange while the coil is wound.

2. The superconducting coil device of claim 1, wherein the winding frame comprises a plurality of frame bodies detachable from the upper flange and the lower flange and detachable from each other.

3. The superconducting coil device of claim 2, wherein the plurality of frame bodies is apart from each other while being fixed to the upper flange and the lower flange.

4. The superconducting coil device of claim 2, wherein two adjacent frame bodies of the plurality of frame bodies are in line contact with each other while being fixed to the upper flange and the lower flange.

5. The superconducting coil device of claim 2, wherein some of the plurality of frame bodies comprise different materials.

6. The superconducting coil device of claim 2, wherein each of the upper flange and the upper fixing plate comprises a hole to pass a wire that forms a coil.

7. The superconducting coil device of claim 6, wherein the upper flange comprises:
an upper flange body comprising a plate shape; and
an upper flange hole formed through the upper flange body and provided to pass the wire therethrough.

8. The superconducting coil device of claim 7, wherein the upper flange comprises an upper flange groove recessed in a bottom surface of the upper flange body that faces the lower flange and formed around the upper flange hole.

9. The superconducting coil device of claim 7, wherein the upper fixing plate comprises:
an upper fixing plate body comprising a plate shape and disposed in the flange body; and
an upper fixing plate hole formed through the upper fixing plate body and overlapping the upper flange hole.

10. The superconducting coil device of claim 9, wherein a size of the upper fixing plate hole is greater than a size of the upper flange hole.

11. The superconducting coil device of claim 9, wherein the upper fixing plate further comprises an upper fixing plate guide provided at an edge portion of the upper fixing plate hole and comprising a curved surface.

12. The superconducting coil device of claim 1, wherein an upper end of the winding frame is inserted into the upper flange and a lower end of the winding frame is inserted into the lower flange.

13. The superconducting coil device of claim 12, wherein a top surface of the winding frame is in surface contact with the upper fixing plate and a bottom surface of the winding frame is in surface contact with the lower fixing plate.

14. A method of manufacturing a superconducting coil device, the method comprising:
engaging a winding frame with an upper flange and a lower flange;
installing a plurality of connecting rods between the upper flange and the lower flange;
installing an upper fixing plate on an upper side of the upper flange;
installing a lower fixing plate on a lower side of the lower flange;
forming a coil by passing a wire through the upper fixing plate and the upper flange and winding the coil on the winding frame;
separating the upper fixing plate from the upper flange;
separating the lower fixing plate from the lower flange; and
separating the winding frame from the upper flange and the lower flange.

15. The method of claim 14, wherein the winding frame comprises a plurality of frame bodies detachable from the upper flange and the lower flange and detachable from each other.

16. The method of claim 15, wherein the plurality of frame bodies is apart from each other while being fixed to the upper flange and the lower flange.

17. The method of claim 15, wherein two adjacent frame bodies of the plurality of frame bodies are in line contact with each other while being fixed to the upper flange and the lower flange.

18. The method of claim 15, wherein some of the plurality of frame bodies comprise different materials.
